(19) United States
(12) Patent Application Publication
(10) Pub. No.: US 2023/0196253 A1
(43) Pub. Date: Jun. 22, 2023

(54) Game Based Training and Work Simulation Platform

(71) Applicant: Bobby Roy, Las Vegas, NV (US)

(72) Inventor: Bobby Roy, Las Vegas, NV (US)

(21) Appl. No.: 18/001,378

(22) PCT Filed: Jun. 18, 2021
(86) PCT No.: PCT/US2021/038075

§ 371 Date: Dec. 9, 2022

Related U.S. Application Data
(60) Provisional application No. 63/040,980, filed on Jun. 18, 2020.

(51) Int. Cl. G06Q 10/0639; G06Q 10/0631; G09B 5/06; G09B 7/02; G06N 3/006

(52) U.S. Cl. CPC G06Q 10/06398; G06N 3/006; G06Q 10/063112; G09B 5/06; G09B 7/02

(57) ABSTRACT

A training and work simulation method is designed to provide a simulated on-the-job environment to offer a use to actually working on client projects while conducting learning and training. Through a unique learn/practice/work program, the method provides learning with multiple tools in multimedia format and integrates performance evaluations at every step. The method facilitates the entire process using actual/simulated projects and incorporates artificial intelligence technologies in various algorithms for generating performance scores for each task and matching job openings for the user. The method provides a holistic online solution for training, onboarding, and working to effectively improve the user’s skills, project strategy and efficiency, and performance, thus equipping the user with significantly improved proficiency and confidence on various projects.

### FIELD OF THE INVENTION

The present invention generally relates to a cloud-based, online training system. More specifically, the present invention relates to an innovated system and method for learning and working suited for any job seeker, student, new-hire employee onboarding, new skill training, team member project performance monitoring, etc.

### BACKGROUND OF THE INVENTION

There is a growing skill gap between what students learn in training and the skills required for performing specific jobs and tasks. Students use various methods and platforms for learning and training, and the resulting fragmentation prevents working processes and workflows from appropriate alignment. Thus, a system that closes the skill gap between learners and skills required in professional workplace is in demand.

According to research, 20% of learning happens in the classroom, but almost 80% occurs on the job, while working on projects. Learning through trial and error, however, takes a long time and is an expensive way to acquire necessary knowledge and skills for a specific job. The education environment can include various parties, such as students or learners, teachers, tutors, recruiters, and the human resource (HR) department, who may maintain transactional and functional relationships of some form with one another.

Traditionally, many placement organizations, HR departments, and educational institutions such as colleges and universities have provided placement services for students based partly on their educational qualifications; such placements may be managed by an applicant tracking system or a HR management system containing the particulars of each student, including job preferences and desired placement companies. Companies have also developed various online systems with which to offer a convenient learning environment that can be shared by potential employers.

Existing online systems may not be sufficient for offering employment opportunities to learning users, each of whom may have completed a unique set of learning application performances on such a system, and a recruiting organization may require education or training that might not be offered by an existing online learning system. Online learning systems are not designed to manage learning applications based on recruitment, the learning application performance experience, and corresponding scores or reviews of a plurality of learning users. In addition, current online learning systems are not properly designed to receive a recruitment request from a potential employer and determine application particulars and minimum metric scores. Accordingly, there is a need to develop a system to solve such problems.

The present invention is intended to address problems associated with and/or otherwise improve on conventional online learning systems through an innovative game based training and work simulation platform (WSP) that is designed to provide a unified system and method for efficiently and effectively closing the skill gap between learners and potential employers while incorporating other problem-solving features.

### SUMMARY OF THE INVENTION

The present invention comprises a unique and innovative game-based training and work simulation platform (WSP) that is designed to provide a unified system and method for efficiently and effectively closing the skill gap between users and potential employers, new-hires and managers, employees and supervisors, etc. The training and work simulation method of the present invention offers businesses a powerful cloud-based, online platform to quickly scale their workforce to match demand, based on project requirements. The method provides a simulated on-the-job environment to offer users (e.g., students, employees, job-seekers, etc.) the next best thing to actually working on client projects while conducting learning and training. In this way, a user can effectively improve their skills, project strategy and efficiency, and performance, thus equipping the user with significantly improved proficiency and confidence on various projects in the field of profession. Using the method, the user can learn, practice, and work by completing a number of typical industry projects, each increasing in complexity with the given deadlines and deliverables. Upon completing the learn/practice/work program, the user can obtain performance ranking scores for the completed projects, which can provide recruiters and clients with far more valuable information about the user’s capabilities than typical certifications can. The method incorporates artificial intelligence technologies in various algorithms for generating performance scores for each task, matching job openings for the user, etc.

The online training and work simulation method facilitates a unique learn/practice/work training program, which is implemented in three modules: learn, practice, and work. This program offers the user multiple learning tools in multimedia format and integrates performance evaluations at every step as the user progresses. During the process, various projects closed related to the subject matter/skills training are provided so that the user can learn from actual/simulated projects, practice with these projects, and work with assigned projects in a monitored environment for performance evaluation. This program also can be used by employers/project managers to monitor a project team working on actual client project and generate quick and accurate performance ranking for each team member. Thus, the method provides a holistic online solution for training, onboarding, and working on projects.

### BRIEF DESCRIPTION OF THE DRAWINGS

FIG. 1 is diagram of the overall system of the present invention.

FIG. 2 is a flowchart of the overall process of the method of the present invention.

FIG. 3 is a flowchart of a sub-process for generating performance scores of the method of the present invention.

FIG. 4 is a flowchart of an alternative embodiment of the sub-process for generating performance scores of the method of the present invention, wherein a swarm artificial intelligence (A) algorithm is used.

FIG. 5 is a flowchart of another embodiment of the sub-process for generating performance scores of the method of the present invention, wherein a time score is provided.

FIG. 6 is a flowchart of another embodiment of the sub-process for generating performance scores of the method of the present invention, wherein the performance scores are converted to numerical values.

FIG. 7 is a flowchart of a sub-process for learn/practice/work training of the method of the present invention.

FIG. 8 is a flowchart of an alternative embodiment of the sub-process for learn/practice/work training of the method of the present invention, wherein skills training is provided.

FIG. 9 is a flowchart of another embodiment of the sub-process for learn/practice/work training of the method of the present invention, wherein software training is provided.

FIG. 10 is a flowchart of another embodiment of the sub-process for learn/practice/work training of the method of the present invention, wherein practice is provided.

FIG. 11 is a flowchart of another embodiment of the sub-process for learn/practice/work training of the method of the present invention, wherein sample projects with varying difficulties are provided for practice.

FIG. 12 is a flowchart of another embodiment of the sub-process for learn/practice/work training of the method of the present invention, wherein a mentor is provided during practice.

FIG. 13 is a flowchart of another embodiment of the sub-process for learn/practice/work training of the method of the present invention, wherein project team is provided in work module.

FIG. 14 is a flowchart of a sub-process for generating and sending a performance ranking of the method of the present invention.

FIG. 15 is a flowchart of an alternative embodiment of the sub-process for generating and sending a performance ranking of the method of the present invention, wherein job matching is provided.

FIG. 16 is a flowchart of another embodiment of the sub-process for generating and sending a performance ranking of the method of the present invention, wherein an AI algorithm is provided for job matching.

FIG. 17 is a flowchart of another embodiment of the sub-process for generating and sending a performance ranking of the method of the present invention, wherein job matching results are relayed to employers and j ob-seekers.

FIG. 18 is a flowchart of the sub-process for learn/practice/work training of the method of the present invention, wherein both users and employers interact through the sub-process.

FIG. 19 is a diagram of the sub-process for learn/practice/work training of the present invention.

FIG. 20 is a flowchart of the sub-process for learning/planning/project steps of the method of the present invention, wherein both users and employers interact through the sub-process.

FIG. 21 is a diagram of the project performance measurement of the present invention.

FIG. 22 is an illustration of an example of the present invention, wherein a flight simulator for software training is provided.

FIG. 23 is an illustration of an example of the present invention, wherein a copilot program for new recruits is provided.

FIG. 24 is an illustration of an example of the present invention, wherein an air traffic control for projects work module is provided.

### DETAIL DESCRIPTIONS OF THE INVENTION

All illustrations of the drawings are for the purpose of describing selected versions of the present invention and are not intended to limit the scope of the present invention.

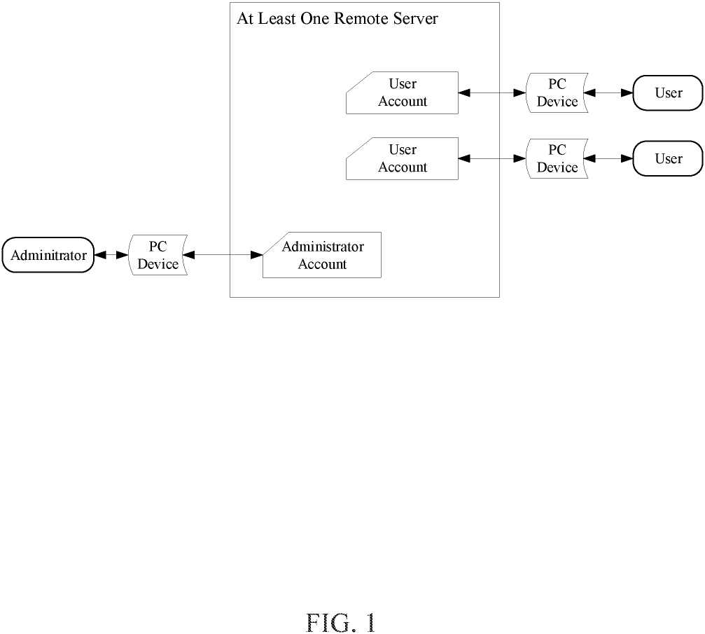

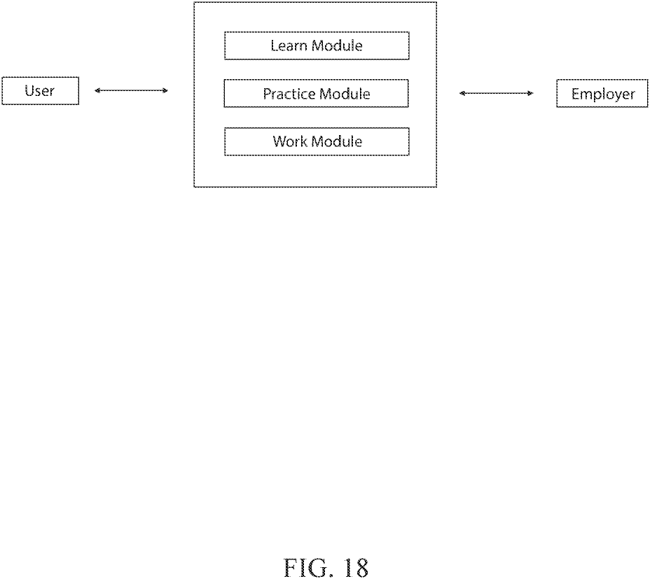

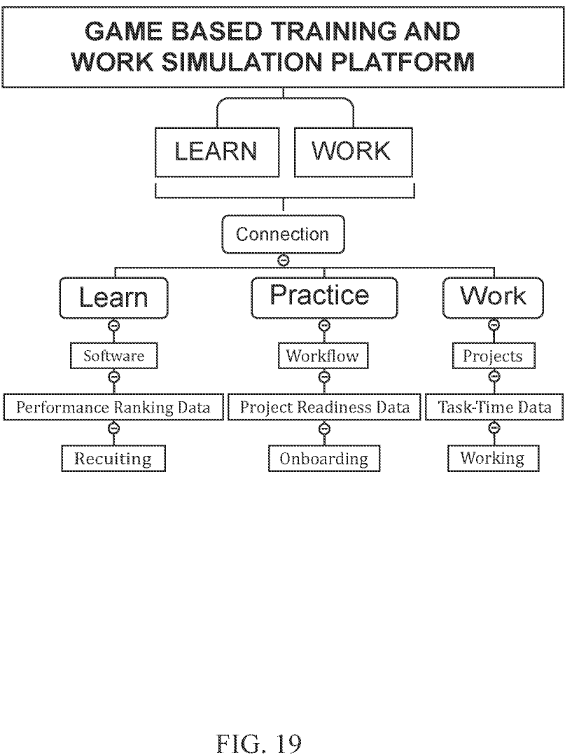

As can be seen in FIG. 1 to FIG. 24, the present invention provides a cloud-based, online system and method designed to bridge the growing skills gap and enable companies to quickly scale their workforce to match demand, based on project requirements. The online system and method, game based training and work simulation platform (WSP) of the present invention, called WSP hereafter, provides a simulated on-the-job environment to offer users (e.g., students, employees, job-seekers, etc.) the next best thing to actually working on client projects. In this way a user can improve their skills, project strategy, time efficiency, and performance so that the user can work confidently and efficiently on various projects, including, but not limited to, software projects. Using the WSP system and method, the user can learn, practice, and work by completing a number of typical industry projects, each increasing in complexity with the given deadlines and deliverables. On completing the learn/practice/work program, the user can obtain performance ranking scores for each project, which can provide recruiters and clients with far more valuable information about users’ capabilities than typical certifications can.

The present invention was developed from the perspective of the 3D (three dimensional) modeling and animation industry, however, the WSP system and method is not limited to any industry and/or software tool.

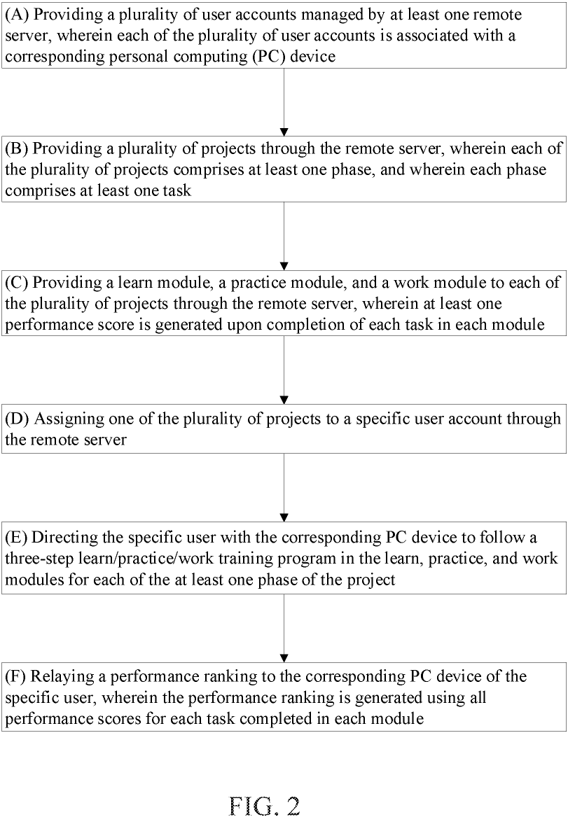

As can be seen in FIG. 1, the present invention provides a holistic training and WSP method and system where a user can learn, practice and work in one unified platform, thus bringing consistency to methods and processes used to create projects while learning and working for a company. This allows for continuous learning and applying the skills on actual client projects based on performance data at each stage. The gamified simulation platform of the present invention provides a just-in-time learning experience and enables the user to gain a high-level proficiency by learning and simultaneously applying the skills gained on an assigned project. To accomplish this, the method of the present invention provides a plurality of user accounts managed by at least one remote server, wherein each of the plurality of user accounts is associated with a corresponding personal computing (PC) device (Step A), as seen in FIG. 2. The corresponding PC device allows a user to interact with the present invention and can be, but is not limited to, phone, cellular phone, smartphone, smart watch, cloud PC, cloud device, network device, personal digital assistant (PDA), laptop, desktop, server, terminal PC, or tablet PC, etc. The users of the user accounts may include relevant parties such as, but are not limited to, individuals, consumers, students, trainees, apprentices, technicians, engineers, employees, workers, teachers, free-lancers, professionals, consultants, software engineers, IT (information technology) professionals, operators, secretaries, supervisors, managers, project managers, officials, business owners, companies, corporations, network companies, cellular companies, government entities, administrators, etc. Further, the at least one remote server is used to manage the training and WSP platform for the plurality of user accounts. The remote server can be managed through an administrator account by an administrator as seen in FIG. 1. The administrator who manages the remote server includes, but is not limited to, owner, service provider, manager, technician, engineer, system engineer, system specialist, software engineer, IT engineer, IT professional, IT manager, IT consultant, service desk professional, service desk manager, consultant, executive officer, chief operating officer, chief technology officer, chief executive officer, president, system administrator, network administrator, company, corporation, organization, etc. Moreover, the remote server is used to execute a number of internal software processes and store data for the present invention. The software processes may include, but are not limited to, server software programs, web-based software applications or browsers embodied as, for example, but not limited to, websites, web applications, desktop applications, cloud applications, and mobile applications compatible with a corresponding user PC device. Additionally, the software processes may store data into internal databases and communicate with external databases, which may include, but are not limited to, training databases, project databases, software databases, job search databases, job opening databases, recruitment databases, employment databases, databases maintaining data about PC devices, databases maintaining project quality records, databases maintaining company information, etc. The interaction with external databases over a communication network may include, but is not limited to, the Internet.

As can be seen in FIG. 2, the overall process of the training and work simulation method of the present invention provides a plurality of projects through the remote server, wherein each of the plurality of projects comprises at least one phase, and wherein each phase comprises at least one task (Step B). More specifically, the plurality of projects may include, but is not limited to, actual client projects, sample projects, practice projects, simulation projects, example projects, training projects, demonstration projects, etc. Additionally, each of the plurality of projects includes, but is not limited to, all common project elements such as deliverables, deadlines, budgets, etc., at least one phase, at least one task for each phase, etc. Further, the method provides a learn module, a practice module, and a work module to each of the plurality of projects through the remote server, wherein at least one performance score is generated upon completion of each task in each module (Step C). More specifically, the method facilitates a unique three-step learn, practice, and work program so that the user can start with learning a new skill, new field of knowledge/technology/trade, new software, etc. After this first step of new matter learning, the user can proceed to practice with sample projects closed related to the subject matter and skill acquired. In this second step, the user gains proficiency through practicing and repeating with the same project or similar projects that the method of the present invention provides. In the third step, the user is provided an actual project or a simulated project to be completed in a format similar to actual project work environment. The user is timed for the entire project work, and the resulting project work is evaluated with a performance ranking.

Subsequently, the method assigns one of the plurality of projects to a specific user account through the remote server (Step D), and directs the specific user with the corresponding PC device to follow the three-step learn/practice/work training program in the learn, practice, and work modules for each of the at least one phase of the project (Step E). With performance scores the method generates based on the outcome of the user’s actual learn/practice/work tasks, the method relays a performance ranking to the corresponding PC device of the specific user, wherein the performance ranking is generated using all performance scores for each task completed in each module (Step F). The performance scores the method generates for each task may include, but are not limited to, time score related to the total time to finish a task, quality score based on the evaluation of the project quality of the task, etc.

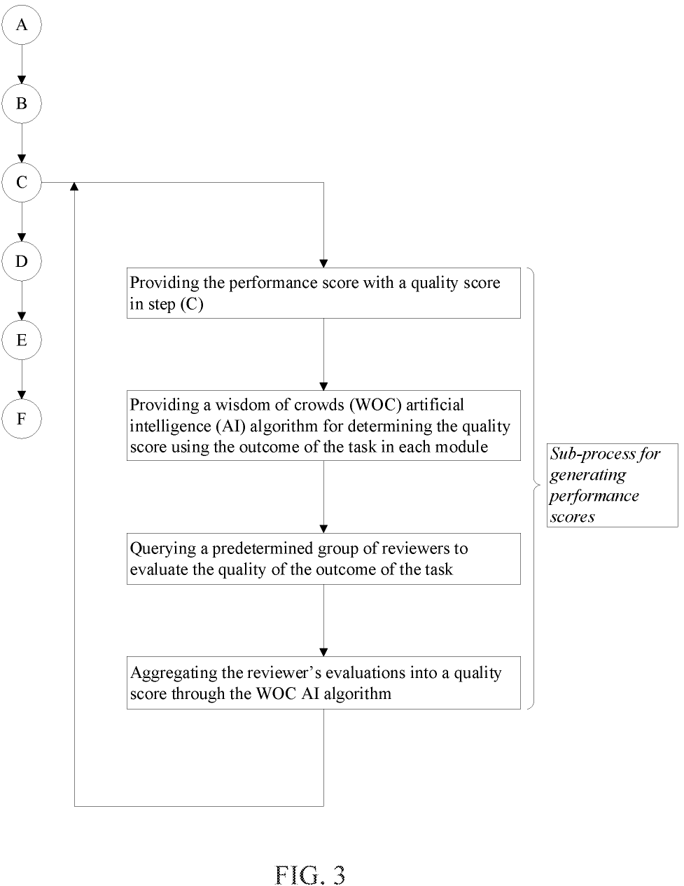

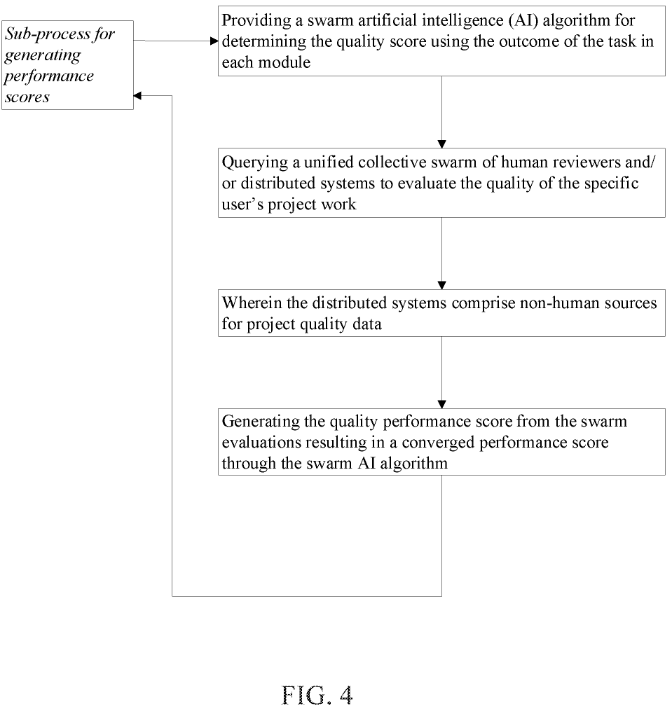

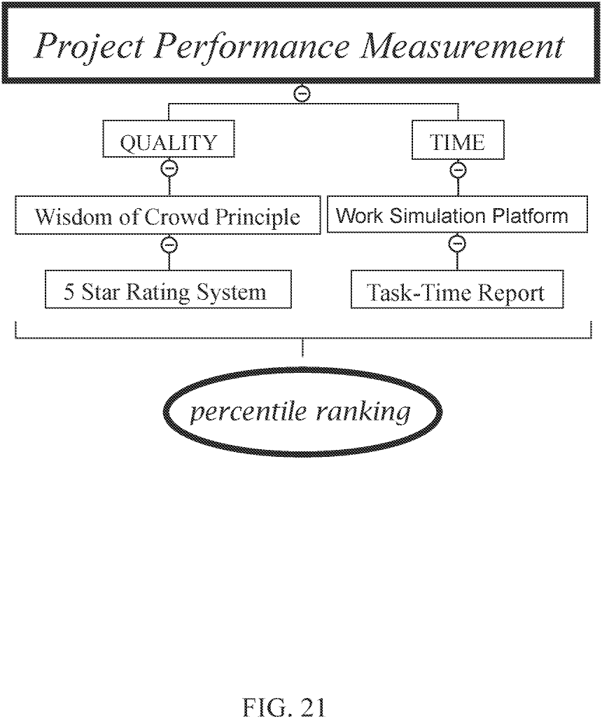

As can be seen in FIG. 3 and FIG. 21, the method of the present invention provides a sub-process for generating performance scores. More specifically, the method provides the performance score with a quality score in Step C. Additionally, the method provides a wisdom of crowds (WOC) artificial intelligence (AI) algorithm for determining the quality score using the outcome of the task in each module. The method queries a predetermined group of reviewers to evaluate the quality of the outcome of the task and aggregates the reviewer’s evaluations into a quality score through the WOC AI algorithm. The reviews of the present invention include, but are not limited to, experts for the subject matter related to the project/task, teachers, professions, any suitable person, etc. The aggregation method may include, but not limited to, any predetermined calculation formula, averaging method, statistical analysis, etc. As can be seen in FIG. 4, in an alternative embodiment of the present invention, the method provides a swarm artificial intelligence (AI) algorithm for determining the quality score using the outcome of the task in each module. This algorithm queries a unified collective swarm of human reviewers and/or distributed systems to evaluate the quality of the specific user’s project work, wherein the distributed systems comprise non-human sources for project quality data. Subsequently, the method generates the quality performance score from the swarm evaluations resulting in a converged performance score through the swarm AI algorithm. The non-human sources may include, but are not limited to, internal and external databases, data tables, reports, etc.

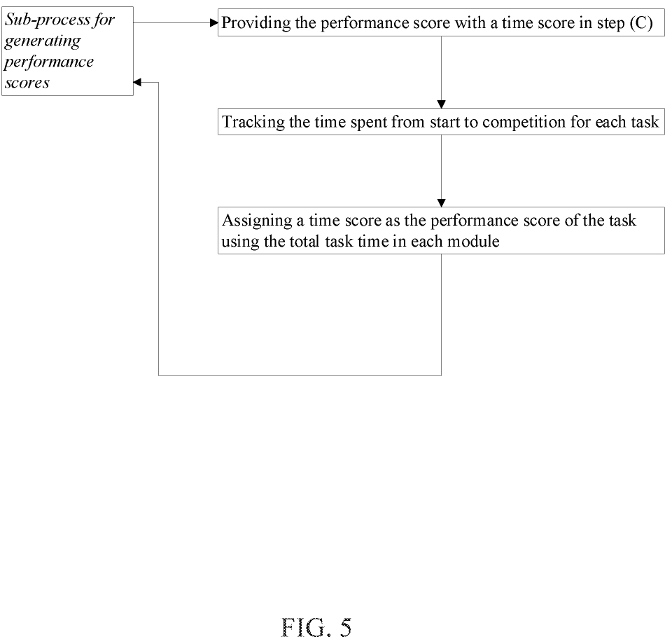

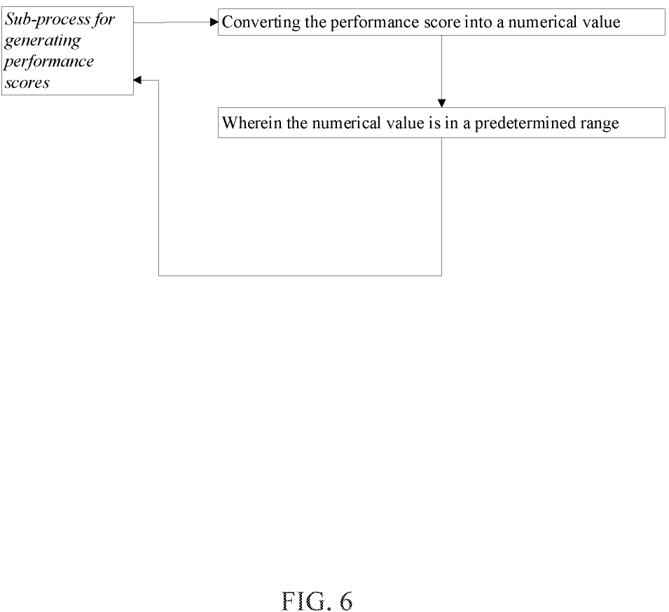

As can be seen in FIG. 5, in another embodiment, the method provides the performance score with a time score in Step C by tracking the time spent from start to competition for each task and assigning a time score as the performance score of the task using the total task time in each module. As can be seen in FIG. 6, in yet another embodiment, the method may convert the performance score into a numerical value wherein the numerical value is in a predetermined range, including, but not limited to, zero (0) to five (5), 0% to 100%, etc.

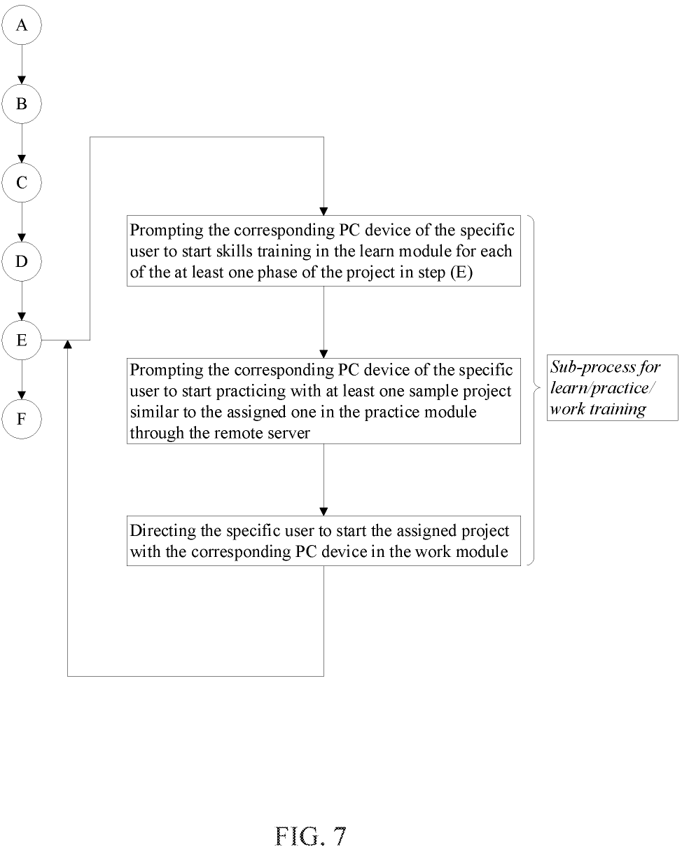

As can be seen in FIG. 7 and FIG. 18 to FIG. 20, the method of the present invention provides a sub-process for learn/practice/work training, the three-step program. More specifically, the method prompts the corresponding PC device of the specific user to start skills training in the learn module for each of the at least one phase of the project in Step E. In the learn module, the specific user is allowed to repeat learning lessons and quizzes improvement and enhanced mastery of the subject matter. Subsequently, the method prompts the corresponding PC device of the specific user to start practicing with at least one sample project similar to the assigned one in the practice module through the remote server. The method facilitates an interactive practice process in the practice module, where the specific user can pause the project work and seek help. Also, the specific user is allowed to repeat the practice project before moving on to the next practice project or the work module. Further, the method directs the specific user to start the assigned project with the corresponding PC device in the work module. In work module, a more formal project work process is monitored, the specific user is timed, and work quality is evaluated.

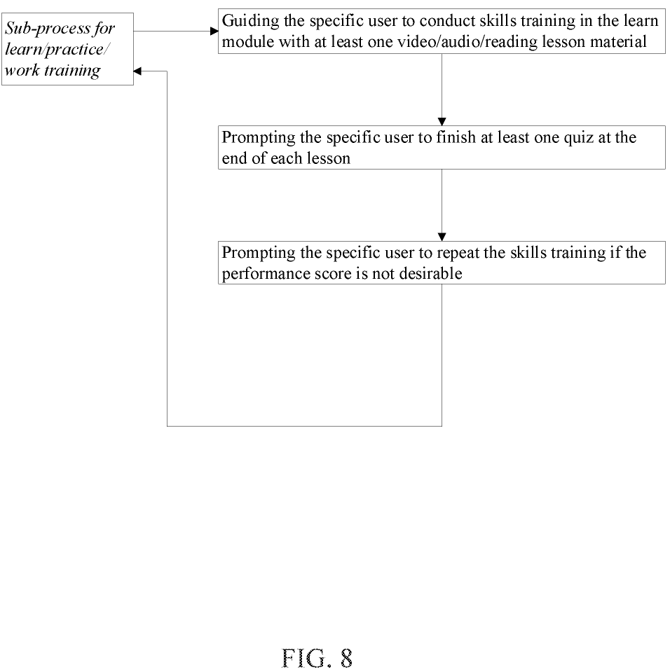

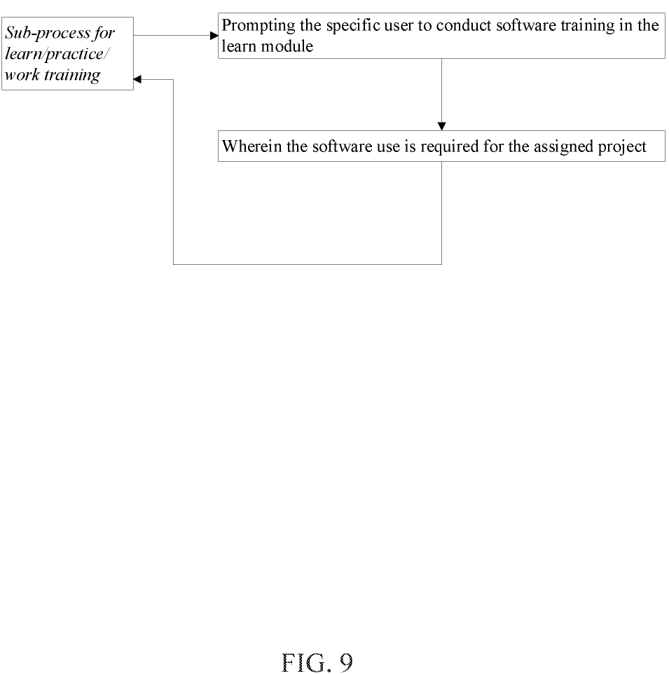

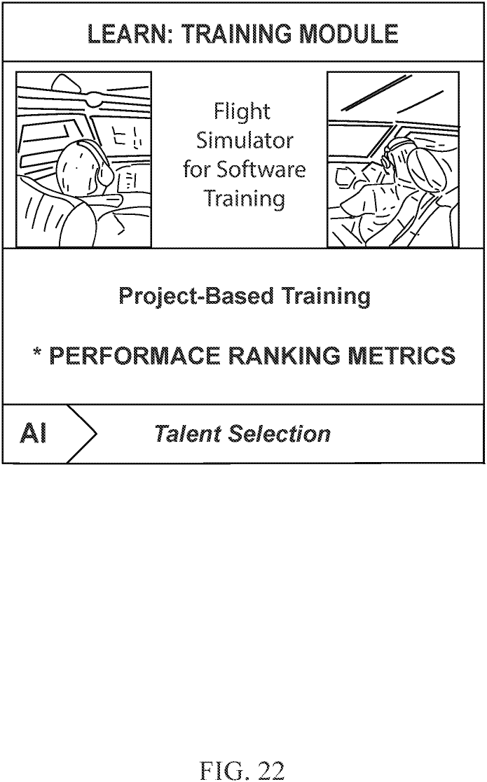

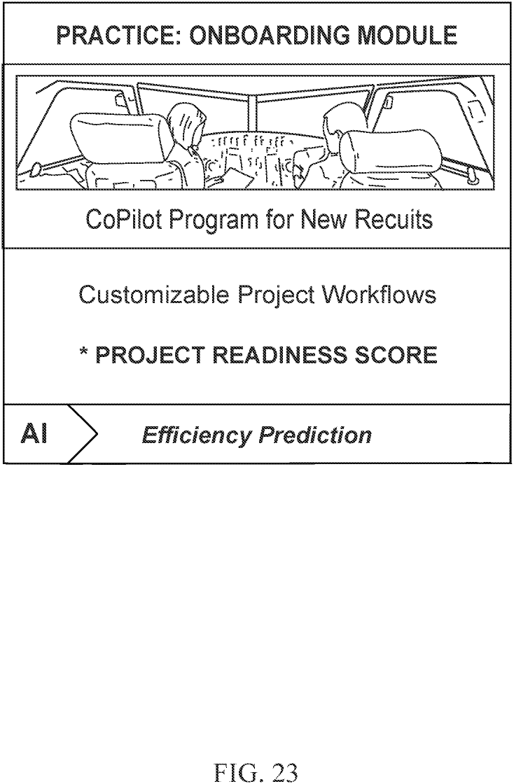

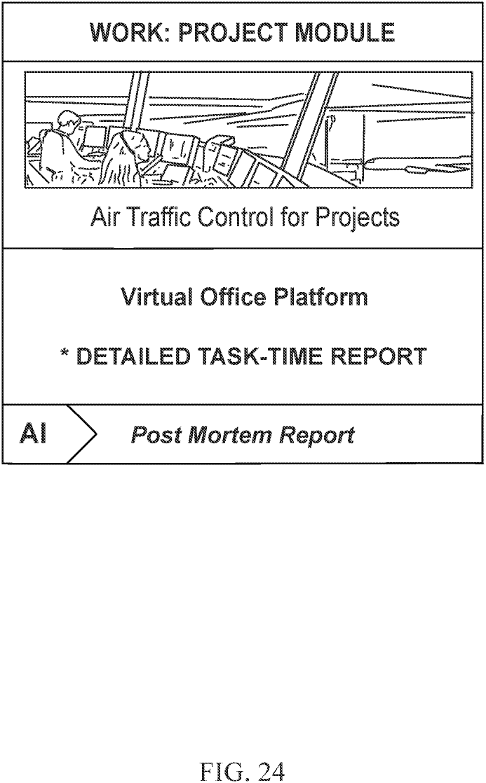

As can be can in FIG. 8, in an alternative embodiment of the sub-process of the three-step program, the method guides the specific user to conduct skills training in the learn module with at least one video/audio/reading lesson material. Subsequently, the method prompts the specific user to finish at least one quiz at the end of each lesson, and prompts the specific user to repeat the skills training if the performance score is not desirable. The skills may include, but are not limited to, 3D (three dimensional) modeling, drawing and crafting, architectural design, etc. As can be can in FIG. 9, in another embodiment of the sub-process of the three-step program, the method prompts the specific user to conduct software training in the learn module, wherein the software use is required for the assigned project. The software may include, but is not limited to, flight simulator as can be seen in FIG. 22, copilot program as can be seen in FIG. 23, air traffic control software as can be seen in FIG. 24, etc.

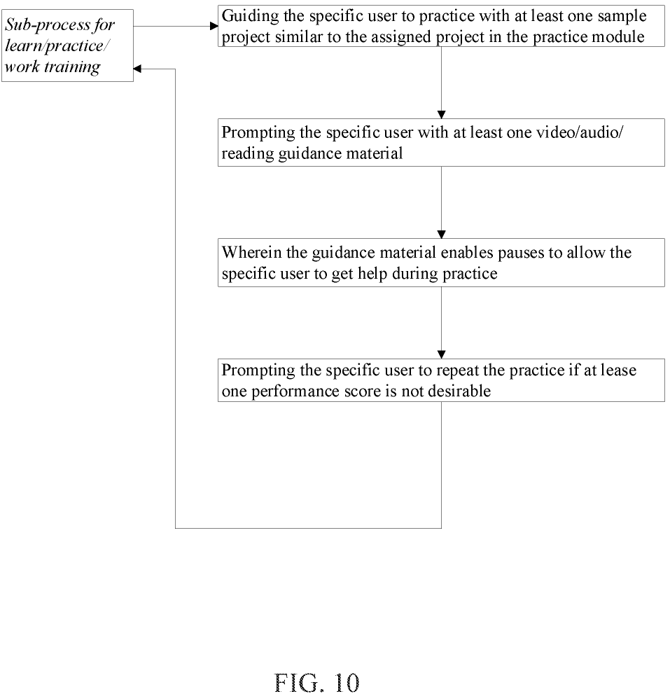

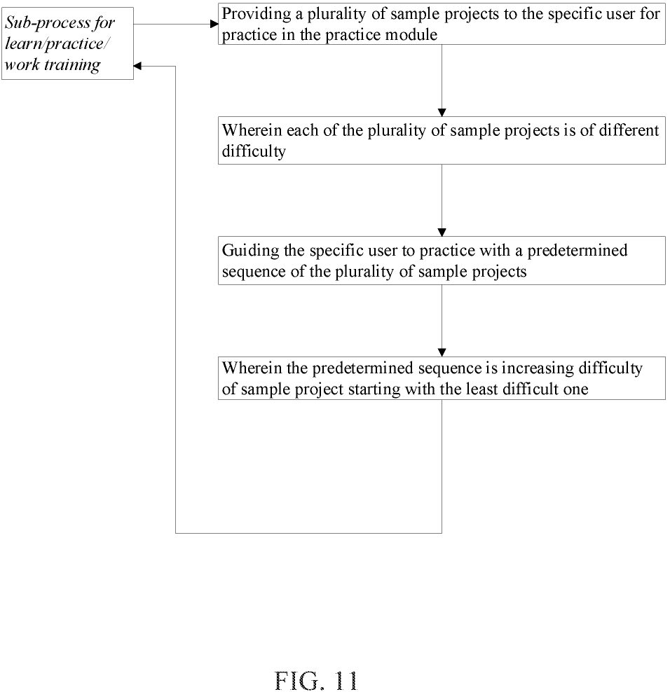

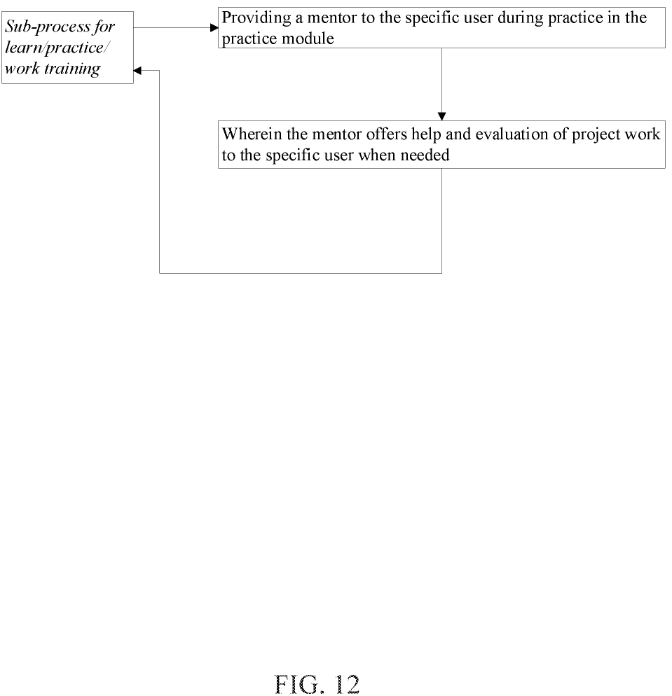

As can be can in FIG. 10, in another embodiment of the sub-process of the three-step program, the method guides the specific user to practice with at least one sample project similar to the assigned project in the practice module. Subsequently, the method prompts the specific user with at least one video/audio/reading guidance material, wherein the guidance material enables pauses to allow the specific user to get help during practice. As can be can in FIG. 11, in another embodiment of the sub-process, the method provides a plurality of sample projects to the specific user for practice in the practice module, wherein each of the plurality of sample projects is of different difficulty. Additionally, the method guides the specific user to practice with a predetermined sequence of the plurality of sample projects, wherein the predetermined sequence is increasing difficulty of sample project starting with the least difficult one. As can be can in FIG. 12, in another embodiment, the method provides a mentor to the specific user during practice in the practice module, wherein the mentor offers help and evaluation of project work to the specific user when needed.

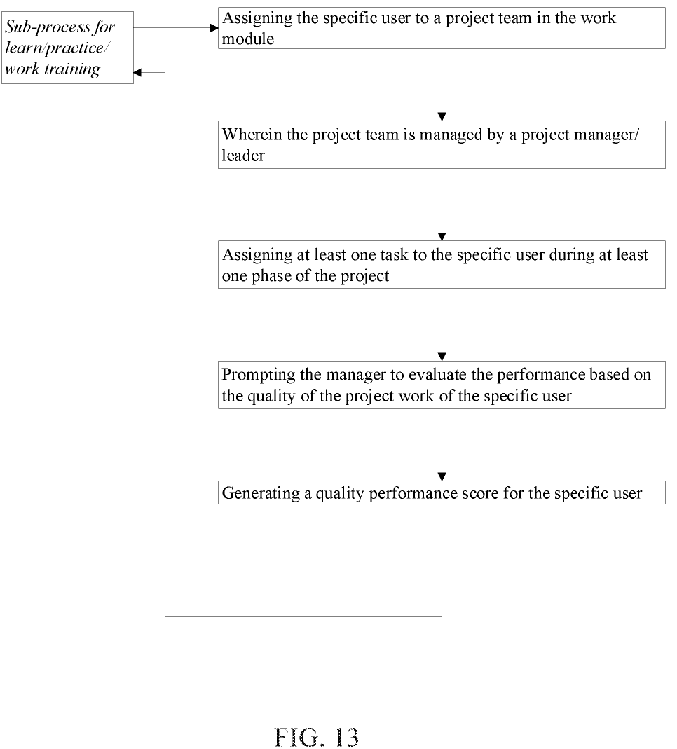

As can be can in FIG. 13, in another embodiment of the sub-process of the three-step program, the method assigns the specific user to a project team in the work module, wherein the project team is managed by a project manager/leader. Subsequently, the method assigns at least one task to the specific user during at least one phase of the project, and prompts the manager to evaluate the performance based on the quality of the project work of the specific user.

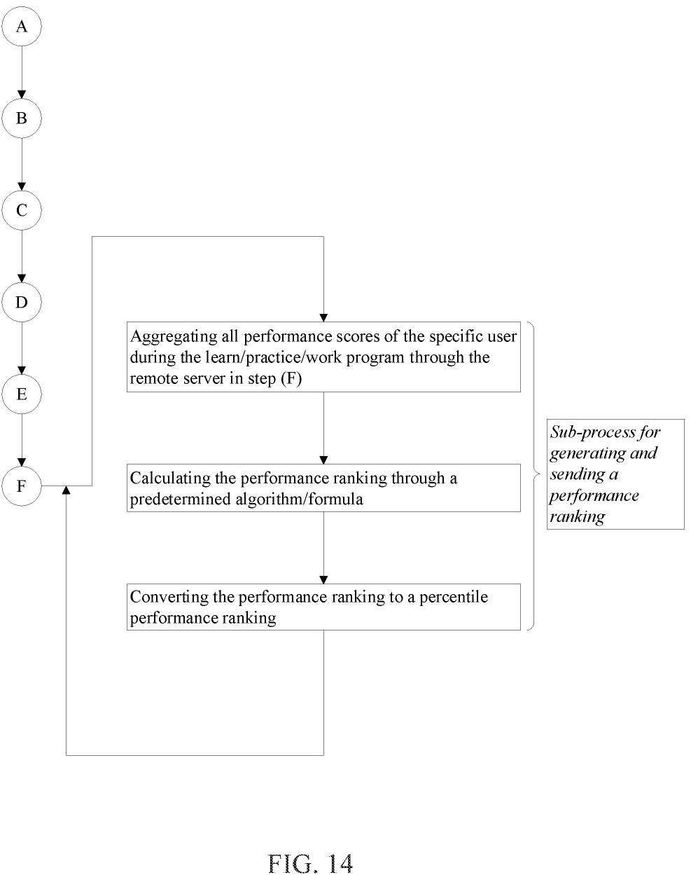

As can be can in FIG. 14, the method provides a sub-process for generating and sending a performance ranking result. More specifically, the method aggregates all performance scores of the specific user during the learn/practice/work program through the remote server in step F and calculates the performance ranking through a predetermined algorithm/formula. Further, the method converts the performance ranking to a percentile performance ranking.

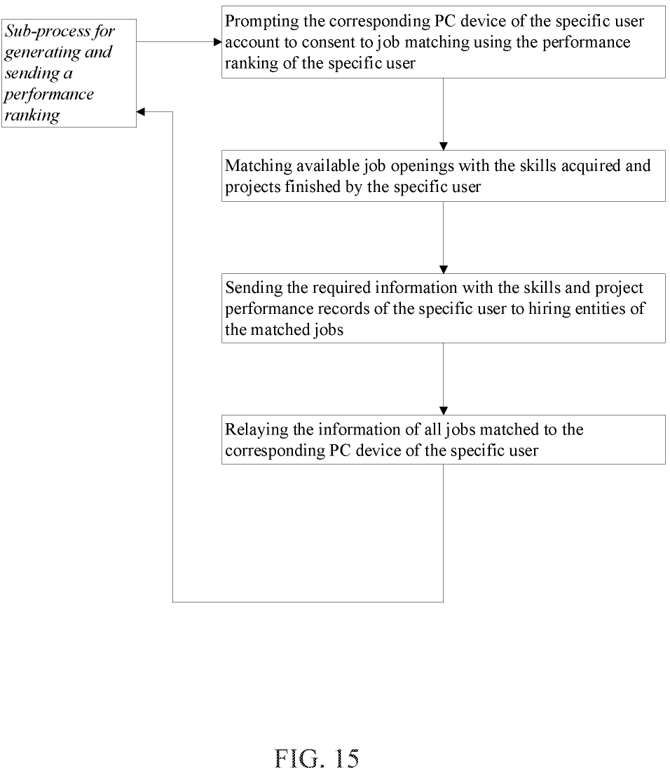

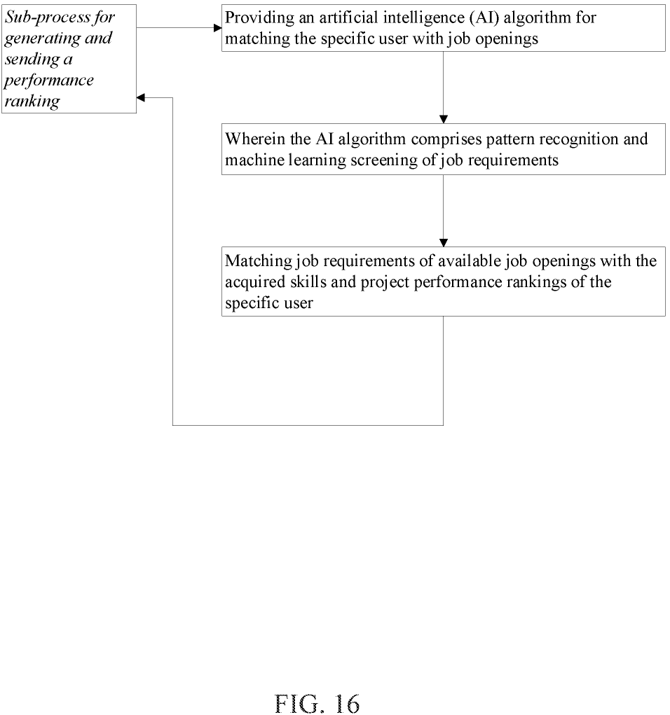

As can be can in FIG. 15, in another embodiment, the method prompts the corresponding PC device of the specific user account to consent to job matching using the performance ranking of the specific user. Subsequently, upon approval by the specific user, the method matches available job openings with the skills acquired and projects finished by the specific user, and sends the required information with the skills and project performance records of the specific user to hiring entities of the matched jobs. Further, the method relays the information of all jobs matched to the corresponding PC device of the specific user. As can be can in FIG. 16, in another embodiment, the method provides an artificial intelligence (AI) algorithm for matching the specific user with job openings, wherein the AI algorithm comprises pattern recognition and machine learning screening of job requirements. Subsequently, the method matches job requirements of available job openings with the acquired skills and project performance rankings of the specific user.

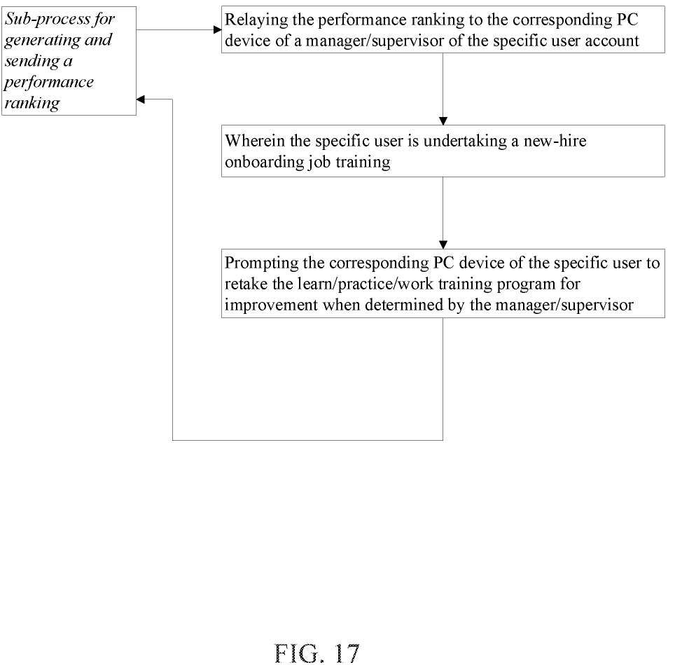

As can be can in FIG. 17, in another embodiment, the method relays the performance ranking to the corresponding PC device of a manager/supervisor of the specific user account, wherein the specific user is undertaking a new-hire onboarding job training. Further, the method prompts the corresponding PC device of the specific user to retake the learn/practice/work training program for improvement when determined by the manager/supervisor.

The learn module may be designed for students in schools/colleges/independent to learn a particular 3D software by working on in-demand industry projects so that, based on their performance ranking results, they can apply for work. The practice module may be designed to allow companies to create custom project-specific workflows and administer to new talent or existing team members before bringing them on board new projects. The work module may be designed to allow companies to have a team work on their projects.

### LEARN MODULE (Worker Training for Recruitment – Software Training)

This module is for job-seekers - students in schools/colleges/independent to learn a particular skill such as 3D software by working on in-demand industry projects and based on their performance ranking results they can apply for work. This module can also be used by companies to train their internal team on new software. The process is as follows:

1. Define projects with deadlines and deliverables like in the real world, typically 3-4 for in-demand projects with each software/application.

2. Project is broken down into phases/stages typically 1 - 4.

3. For each phase students use our 3-step training methodology to go through the process.

4. Step 1 is to learn the software; Step 2 is to practice workflow and Step 3 is test their performance (based on given project and tracking time).

5. In step 1 for learning software the participant learns the software tools and menus by watching videos, and then prepares for step 2 to learn the workflow for a similar project they have been assigned through carefully prepared videos broken down into steps which are converted into tasks for the performance part.

6. For the performance the student completes the tasks associated with each phase with the timer running in the platform to measure accurate time for each task, phase and overall project.

7. The quality of the project is reviewed by at least 3 people (wisdom of crowd) and ranked on a scale from 1-5 stars.

8. Since the project assigned is fixed, based on the stars and time taken a performance percentile rank from 0-100 is assigned.

9. If the student gets low scores they can try the project again and again till they reach a satisfactory ranking established by market demand.

10. Based on the performance ranking score companies can hire skilled candidates for specific projects/work.

### PRACTICE MODULE (Project Onboarding)

This module is for companies to create their custom project-specific workflows and administer to the new talent/hire or existing team members before onboarding them on new projects. The core steps are similar to the learn module however the differences are as follows:

1. Here the project is defined by the company based on typical projects the company works on and might involve using multiple software (rather than just one in the learn phase).

2. The project is broken down into phases and here participants might be asked to work on a single phase/part of the project.

3. In this stage the participant is provided with a company mentor to guide through the process.

4. The quality of the project is reviewed by at least 3 people from the company (wisdom of crowd) and ranked on a scale from 1-5 stars.

5. Based on the ranking and time the participant receives project readiness metrics. The participant can redo the project for a higher degree of project readiness.

6. The company can assign the participant to work on phases of the client projects or the entire project based on readiness metrics.

### WORK MODULE (Project Work)

The module is for companies to have the team work on their projects. Since the previous modules are also project driven the format is similar except for some of the key differences.

1. Here the project is assigned in an actual client project.

2. The project is broken down into phases and here participants might be asked to work on a single phase/part of the project.

3. In this stage the participant collaborates with the team and a manager and is assigned tasks for each phase.

4. The participant works on the tasks they select and phase in the platform and the platform tracks the time spent on each task and phase.

5. At the end of the day the platform automatically allows the participant to fill out their timesheets based on the time spent on the platform.

6. The quality of the project is reviewed by the manager and ranked on a scale from 1-5 stars.

Based on the time spent on the tasks the company gets a task time report to measure the efficiency of the project.

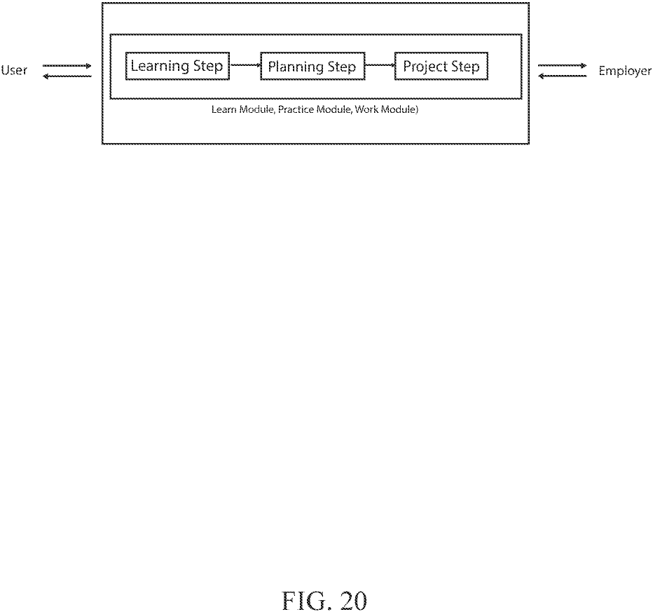

Each of the three different modules of the present invention—the learn module, practice module, and work module—may include a project step, a planning step, and a learning step, as shown in FIG. 20.

### Project Step

The project step may include a process to assign the user a project with deliverables and timeline, just as in real-world client settings.

In the learn module, the project step may define projects with deadlines and deliverables just as in the real world, typically 3 to 4 for in-demand projects using each software program.

In the practice module, the project step may be configured to allow companies to define a project based on their typical projects that might involve use of multiple software programs.

In the work module of the present invention, the project step may be configured to allow companies to assign client projects to their team (e.g. employees).

### Planning Step

The planning step may include a process for breaking the project down into phases, just as a company would do using project management software, with timelines and deliverables for each phase.

In the learn module, the project can be broken down into phases/stages (typically about 4 phases).

In the practice module, the project can be broken down into phases and the users can be asked to work on a single phase/part.

In the work module, the project can be broken down into phases and the users can also be asked to work on a single phase/part.

### Learning Step

The learning step may include a process whereby the user learns the software tools and menus needed for each phase using videos and accompanying quizzes, then may learn the recommended project workflow using videos with practice pauses, which may prompt learners to alternate watching and trying.

In some embodiments, users may apply their learning to the project assigned to them, timing themselves.

In some embodiments, based on the project completion, the user may receive two or more separate scores based on time and quality of work. In some other embodiments, the learning step may provide aggregate scores from multiple reviews on a rating scale. In cases of visual design projects, for which ratings are difficult to obtain, the learning step may be configured to take advantage of the wisdom of crowds, with the collective intelligence of a group determining the visual rating.

In the learn module that is designed for software training, the learning step may allow the users to first learn the software, then practice the workflow, and finally test their performance (based on the given project, while tracking time). For example, while learning the software, users may learn to use software tools and menus by watching videos, then prepare for the second step where the users can learn the workflow for a similar project to the one they have been assigned with the aid of carefully prepared videos broken down into multiple phases that can be converted into tasks. For testing their performance, users can complete the tasks associated with each phase as the timer runs in the platform, accurately timing each task and phase as well as the overall project.

Project quality can be reviewed by at least a group of people (taking advantage of the wisdom of crowds) and ranked on a rating scale. Because the assigned project is fixed, the ranking and time taken can be translated to a performance percentile rank.

In some embodiments, the learning step can be configured such that a user who scores below a certain threshold can retry the project until reaching a satisfactory ranking established by market demand.

In some embodiments, the learning step of the present invention may include a process for sending companies performance ranking scores, as shown in FIG. 21, based on which they can hire skilled candidates for specific projects.

In the practice module, the learning step may provide users with a company mentor to guide them through the learning step. Project quality can be reviewed by at least 3 people from the company (wisdom of crowd) and ranked on a rating scale.

Based on ranking and time, the user may receive project readiness metrics by the learning step.

In some embodiments, the learning step may allow the user to redo the project to achieve a higher degree of project readiness. In other embodiments, the company can assign the user to work on certain phases of client projects or the entire project, based on readiness metrics.

In the work module, the learning step may allow the user to collaborate with the team (e.g., employees), and a manager and the user can be assigned tasks for each phase. Users may work on the tasks and phase of their choice, and the learning step can be configured to track the time spent on each.

In some embodiments, the WSP may automatically allow users to fill out their timesheets based on their time spent on projects using WSP of the present invention. The quality of the project can be reviewed by the manager and ranked on a rating scale. In some embodiments, all of the three modules of WSP can be configured to send a task-time report to a company so that it can gauge efficiency based on time spent on each project and tasks.

The steps and the processes described in connection with the embodiments disclosed herein can be embodied entirely online, directly in hardware, or in a software module executed by a processor, or in a combination of the three. A software module can reside in a memory unit that can include volatile memory, non-volatile memory, and network devices, or other data storage devices now known or later developed for storing information/ data. The volatile memory may be any type of volatile memory including, but not limited to, static or dynamic, random access memory (SRAM or DRAM). The non-volatile memory may be any non-volatile memory including, but not limited to, ROM, EPROM, EEPROM, flash memory, and magnetically or optically readable memory or memory devices such as compact discs (CDs) or digital video discs (DVDs), magnetic tape, and hard drives.

The computing device may be a laptop computer, a cellular phone, a personal digital assistant (PDA), a tablet computer, and other mobile devices of the type. Communications between components and/or devices in the systems and methods disclosed herein may be unidirectional or bidirectional electronic communication through a wired or wireless configuration or network. For example, one component or device may be wired or networked wirelessly directly or indirectly, through a third-party intermediary, over the Internet, or otherwise with another component or device to enable communication between the components or devices. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, 5G network, and other communication networks of the type. In example embodiments, network can be configured to provide and employ 5G wireless networking features and functionalities.

Although the invention has been explained in relation to its preferred embodiment, it is to be understood that many other possible modifications and variations can be made without departing from the spirit and scope of the invention as hereinafter claimed.

What is claimed is:

1. A method for training and work simulation comprising the steps of:
(A) providing a plurality of user accounts managed by at least one remote server, wherein each of the plurality of user accounts is associated with a corresponding personal computing (PC) device;
(B) providing a plurality of projects through the remote server, wherein each of the plurality of projects comprises at least one phase, and wherein each phase comprises at least one task;
(C) providing a learn module, a practice module, and a work module to each of the plurality of projects through the remote server, wherein at least one performance score is generated upon completion of each task in each module;
(D) assigning one of the plurality of projects to a specific user account through the remote server;
(E) directing the specific user with the corresponding PC device to follow a three-step learn/practice/work training program in the learn, practice, and work modules for each of the at least one phase of the project; and
(F) relaying a performance ranking to the corresponding PC device of the specific user, wherein the performance ranking is generated using all performance scores for each task completed in each module.

2. The method for training and work simulation as claimed in claim 1 comprising the steps of:
providing the performance score with a quality score in step (C);
providing a wisdom of crowds (WOC) artificial intelligence (AI) algorithm for determining the quality score using the outcome of the task in each module;
querying a predetermined group of reviewers to evaluate the quality of the outcome of the task; and
aggregating the reviewer’s evaluations into a quality score through the WOC AI algorithm.

3. The method for training and work simulation as claimed in claim 1 comprising the steps of:
providing a swarm artificial intelligence (AI) algorithm for determining the quality score using the outcome of the task in each module;
querying a unified collective swarm of human reviewers and/or distributed systems to evaluate the quality of the specific user’s project work;
wherein the distributed systems comprise non-human sources for project quality data; and
generating the quality performance score from the swarm evaluations resulting in a converged performance score through the swarm AI algorithm.

4. The method for training and work simulation as claimed in claim 1 comprising the steps of:
providing the performance score with a time score in step (C);
tracking the time spent from start to competition for each task; and
assigning a time score as the performance score of the task using the total task time in each module.

5. The method for training and work simulation as claimed in claim 1 comprising the steps of:
converting the performance score into a numerical value; and
wherein the numerical value is in a predetermined range.

6. The method for training and work simulation as claimed in claim 1 comprising the steps of:
prompting the corresponding PC device of the specific user to start skills training in the learn module for each of the at least one phase of the project in step (E);
prompting the corresponding PC device of the specific user to start practicing with at least one sample project similar to the assigned one in the practice module through the remote server; and
directing the specific user to start the assigned project with the corresponding PC device in the work module.

7. The method for training and work simulation as claimed in claim 6 comprising the steps of:
guiding the specific user to conduct skills training in the learn module with at least one video/audio/reading lesson material;
prompting the specific user to finish at least one quiz at the end of each lesson; and
prompting the specific user to repeat the skills training if the performance score is not desirable.

8. The method for training and work simulation as claimed in claim 6 comprising the steps of:
prompting the specific user to conduct software training in the learn module; and
wherein the software use is required for the assigned project.

9. The method for training and work simulation as claimed in claim 6 comprising the steps of:
guiding the specific user to practice with at least one sample project similar to the assigned project in the practice module;
prompting the specific user with at least one video/audio/reading guidance material; and
wherein the guidance material enables pauses to allow the specific user to get help during practice.

10. The method for training and work simulation as claimed in claim 6 comprising the steps of:
providing a plurality of sample projects to the specific user for practice in the practice module; and
wherein each of the plurality of sample projects is of different difficulty.

11. The method for training and work simulation as claimed in claim 10 comprising the steps of:
guiding the specific user to practice with a predetermined sequence of the plurality of sample projects; and
wherein the predetermined sequence is increasing difficulty of sample project starting with the least difficult one.

12. The method for training and work simulation as claimed in claim 6 comprising the steps of:
providing a mentor to the specific user during practice in the practice module; and
wherein the mentor offers help and evaluation of project work to the specific user when needed.

13. The method for training and work simulation as claimed in claim 6 comprising the steps of:
assigning the specific user to a project team in the work module;
wherein the project team is managed by a project manager/leader;
assigning at least one task to the specific user during at least one phase of the project; and
prompting the manager to evaluate the performance based on the quality of the project work of the specific user.

14. The method for training and work simulation as claimed in claim 1 comprising the steps of:
aggregating all performance scores of the specific user during the learn/practice/work program through the remote server in step (F); and
calculating the performance ranking through a predetermined algorithm/formula.

15. The method for training and work simulation as claimed in claim 14 comprising the steps of:
converting the performance ranking to a percentile performance ranking.

16. The method for training and work simulation as claimed in claim 1 comprising the steps of:
prompting the corresponding PC device of the specific user account to consent to job matching using the performance ranking of the specific user;
matching available job openings with the skills acquired and projects finished by the specific user;
sending the required information with the skills and project performance records of the specific user to hiring entities of the matched jobs; and
relaying the information of all jobs matched to the corresponding PC device of the specific user.

17. The method for training and work simulation as claimed in claim 16 comprising the steps of:
providing an artificial intelligence (AI) algorithm for matching the specific user with job openings;
wherein the AI algorithm comprises pattern recognition and machine learning screening of job requirements; and
matching job requirements of available job openings with the acquired skills and project performance rankings of the specific user.

18. The method for training and work simulation as claimed in claim 1 comprising the steps of:
relaying the performance ranking to the corresponding PC device of a manager/supervisor of the specific user account; and
wherein the specific user is undertaking a new-hire onboarding job training.

19. The method for training and work simulation as claimed in claim 1 comprising the steps of:
prompting corresponding PC device of the specific user to retake the learn/practice/work training program for improvement when determined by the manager/supervisor.
